(19) United States
(12) Patent Application Publication
(10) Pub. No.: US 2010/0026969 A1
(43) Pub. Date: Feb. 4, 2010

(54) Projection system

(76) Inventor: Ho Joong Kang, Seoul (KR)

Correspondence Address: MCKENNA LONG & ALDRIDGE LLP, 1900 K STREET, NW, WASHINGTON, DC, 20006, US

(21) Appl. No.: 12/461,075

(22) Filed: Jul. 30, 2009

(30) Foreign Application Priority Data
Aug. 1, 2008 (KR) 10-2008-0075552

(51) Int. Cl. G03B 21/28; F21V 11/00

(52) U.S. Cl. 353/81; 362/235

(57) ABSTRACT

A projection system is disclosed. An object of the present invention is to provide a projection system that is able to present brighter images efficiently. A projection system includes a plurality of light sources generating lights, a light source composition part comprising a plurality of protrusions facing the light sources, respectively, to compose the lights incident from the light sources, and an optical system emitting the light outside from the light source composition part.

### CROSS REFERENCE TO RELATED APPLICATION

This application claims the benefit of the Patent Korean Application No. 10-2008-0075552, filed on Aug. 1, 2008, which is hereby incorporated by reference as if fully set forth herein.

### BACKGROUND OF THE DISCLOSURE

1. Field of the Disclosure

The present invention relates to a projection system, more particularly, to a projection system that is able to enhance brightness of a light source provided therein.

2. Discussion of the Related Art

A display device adapting an optical projection system, for example, a projection TV or projector may uses a light source such as lamp, light emitting diode (LED) and later diode (LD).

Recently, there have been increasing demands for a large screen and a brighter optical projection system of such a projector or projection display to display images in circumstances having bright external lights without any problems.

The brightness of such the system is in relation with the amount of light incident from a light source, a micro-device used in the projector or the projection system and the size of the optical system.

### SUMMARY OF THE DISCLOSURE

Accordingly, the present invention is directed to a projection system.

An object of the present invention is to provide a projection system that is able to present brighter images efficiently.

Another object of the present invention is to provide a projection system that uses a prism as means of composing two lights to present substantially identical optical characteristics to a case of using a single light source.

Additional advantages, objects, and features of the disclosure will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a projection system includes a plurality of light sources generating lights; a light source composition part comprising a plurality of protrusions facing the light sources, respectively, to compose the lights incident from the light sources; and an optical system emitting the light outside from the light source composition part.

Here, each of the light sources may generate white unpolarized light. The lights generated from the plurality of the light sources may be incident on an identical incidence surface.

At least four protrusions of the light source composition part may be provided. Each of the protrusions may include a first surface that is perpendicular to a light shaft of the light incident from the light source and a second surface.

The light source emitting the light to the first surface of each protrusion may be different from the light source emitting the light to the second surface of each protrusion. The first surface of one of the protrusion may face the second surface of another that is adjacent to the protrusion and the second surface of one of the protrusion may face the first surface of another that is adjacent to the protrusion.

Another aspect of the present invention, a projection system includes first and second light sources generating lights incident on an identical incidence surface, respectively; a plurality of prisms arranged on the incidence surface in parallel to compose the lights of the first and second light sources; and an optical system emitting the lights composed by the plurality of the prisms outside.

At least four prisms may be provided. Each of the prisms may be configured of a trigonal prim shape having a first, second third surface.

Here, the first surface of each prism may be perpendicular to a light shaft of the light incident from the first light source, and the second surface of each prism may be perpendicular to a light shaft of the light incident from the second light source, and the third surface of each prism may be in parallel to the incidence surface.

The first surface of one of the prisms may face the second surface of another that is adjacent to the prism, and the second surface of one of the prisms may face the first surface of another that is adjacent to the prism, and an edge of the third surface of one of the prisms may be in contact with an edge of the third surface of another that is adjacent to the prism.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure.

In the drawings:

FIGS. 1 and 2 are diagrams illustrating irradiance of a single light source, respectively;

FIGS. 3 and 4 are diagrams illustrating irradiance of two light sources, respectively;

FIGS. 5 and 6 are diagrams illustrating brightness that is not increased when two light sources are used in a system having identical effective areas, respectively;

FIG. 8 is a diagram illustrating brightness that is able to be increased by spatial re-arrangement of two light sources;

FIG. 9 is a diagram illustrating brightness that is not increased in case of the identical light source;

FIG. 10 is a diagram illustrating etendue that is not changed even in case of using two lamps;

FIG. 11 is a diagram illustrating a progress of light in case of using a single prism;

FIGS. 12a to 12c are diagrams illustrating spatial re-arrangement of light in case of using two prisms;

FIGS. 13a to 13c are diagrams illustrating spatial re-arrangement of light in case of using four prisms;

FIGS. 14a and 14b are diagrams illustrating spatial re-arrangement of light in case of using six prisms;

FIGS. 15a and 15b are diagrams illustrating spatial re-arrangement of light in case of using eight prisms;

FIGS. 16a and 16b are diagrams illustrating spatial re-arrangement of light in case of using ten prisms;

FIGS. 17a and 17b are diagrams illustrating spatial re-arrangement of light in case of using twelve prisms;

FIGS. 18a and 18b are diagrams illustrating spatial re-arrangement of light in case of using fourteen prisms;

FIGS. 19a and 19b are diagrams illustrating spatial re-arrangement of light in case of using sixteen prisms;

FIGS. 20a and 20b are diagrams illustrating spatial re-arrangement of light in case of using eighteen prisms;

FIGS. 21a and 21b are diagrams illustrating spatial re-arrangement of light in case of using twenty prisms;

FIGS. 22a and 22b are diagrams illustrating spatial re-arrangement of light in case of using forty prisms;

FIGS. 23a and 23b are diagrams illustrating spatial re-arrangement of light in case of using sixty prisms;

FIGS. 24a and 24b are diagrams illustrating spatial re-arrangement of light in case of using eighty prisms;

FIGS. 25a and 25b are diagrams illustrating spatial re-arrangement of light in case of using hundred prisms;

FIGS. 26a and 26b are graphs illustrating increase of brightness in an effective area in an optical system in case of using plural prisms;

FIGS. 27a and 27b are diagrams illustrating composition state of light emitted from two lamps to show a single irradiance completely;

FIG. 28 is a diagram illustrating an embodiment of a projector system including a light system having brightness increased by a prism;

FIG. 29 is a diagram illustrating a projection system according to the present invention;

FIG. 30 is a diagram visually illustrating a progress of light in the projection system of FIG. 29.

### DESCRIPTION OF SPECIFIC EMBODIMENTS

Reference will now be made in detail to the specific embodiments of the present invention, examples of which are illustrated in the accompanying drawings. Wherever possible, the same reference numbers will be used throughout the drawings to refer to the same or like parts.

It is necessary to define an etendue in order to explain an optical system according to the present invention. The etendue is referenced to as the amount in proportion to an area light-emitting or receiving light and in proportion to a light-emitting or light-receiving space angle. Here, the etendue may be presented as a following algebraic expression and this is the amount preserved in an optical system having no aberration under Abbe's Sine condition.

$$\begin{matrix}Etendue = {n}^{2} \int \int d A cos θ d Ω \\ = {n}^{2} {A}_{0} \int cos θ d Ω \\ = π {n}^{2} {A}_{0} {sin}^{2} {θ}_{0}\end{matrix} \qquad [ Algebraic Expression 1 ]$$

Here, ‘n’ is a refractive index. ‘A0’ is an area of a light source. ‘θ₀’ is an angle of light emitted from A0. the etendue (E) and the light velocity (Φ) may be described in a relation from such Algebraic Expression 1.

Specifically, the conventional definition of light velocity is referenced to as Algebraic Expression 2. Here, if it is premised that brightness of the light source is regular (L0) referenced to as Lambertian, Algebraic Expression 2 may be expressed as Algebraic Expression 3.

Φ=∫∫L(\vec{r},\hat{n})dA cos θdΩ [Algebraic Expression 2]

Φ=L₀∫∫dA cos θdΩ [Algebraic Expression 3]

As a result, the relation between the light velocity and the etendue may be expressed as Algebraic Expression 3.

$$Φ = \frac{{L}_{0}}{{n}_{0}^{2}} E \qquad [ Algebraic Expression 4 ]$$

That is, the light velocity is in proportion to the etendue and there is difference as much as a value multiplied by a constant. As a result, if the etendue is known, the light velocity of the area receiving light may be known.

The algebraic expressions expressing the relation between the etendue and the light velocity may be defined under following three preconditions. If the etendue of a light source and the etendue of the light-receiving part are known by using the expressions, the light velocity useable in the light source may be found out substantially easily.

First, the etendue is the amount that is preserved in an optical system having no aberration;

Second, irradiance is uniform according to a position of a light-emitting area of the light source; and

Third, the distribution of a light-emitting angle of the light source is ‘Lambertian’.

The second one of the three preconditions on the definition of the etendue is not applicable to conventional light sources.

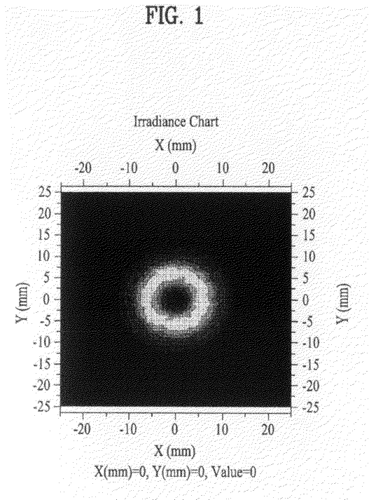

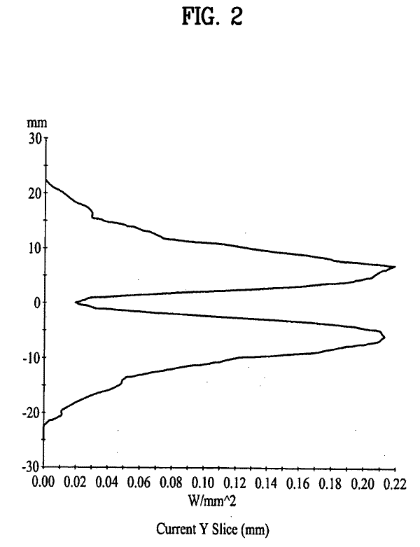

In case of a UHP lamp that is typically used in a projector, light emitted from Arc is reflected on a reflector and then the light is emitted. Here, irradiance according to each position of Arc is not uniform. And the irradiance of the light reflected on the reflector is not uniform according to each position as shown in FIGS. 1 and 2.

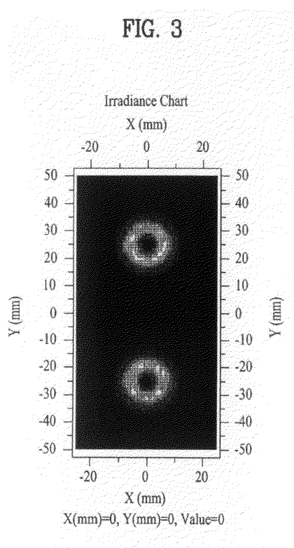

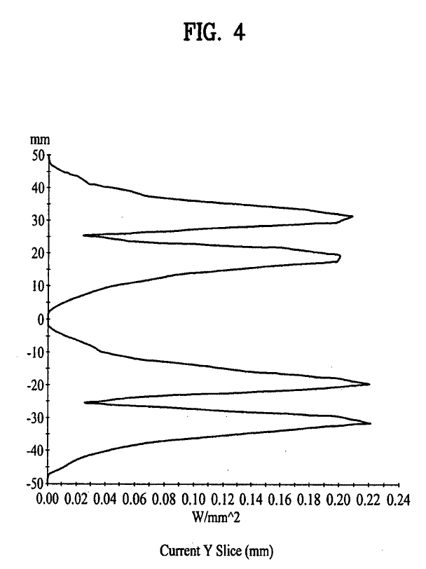

If two lamps are installed in the projector, two UHP lamps are arranged in parallel with respect to the optical system, spatial irradiance shows as FIGS. 3 and 4.

in case that an actual optical system using a single lamp is used, only predetermined area of the light area emitted from the lamp is used. As a result, the brightness of this case is identical or deteriorated in comparison to a case of using a single lamp.

As mentioned above, even if two lamps are used in the projector, the simple arrangement of the two lamps in parallel can not improve efficiency of the optical system.

To improve the efficiency of the optical system, the characteristics of the etendue of the light source should be improved. For that, a following method will be useable.

First of all, an arc gap of the lamp is reduced to reduce a light-emitting area and the light velocity is maintained. This method uses a fact that the useable light amount increases more and more with respect to the identical etendue as the arc gap of the lamp is reduced more and more.

Next, a method of composing two lamps in a single path may be useable.

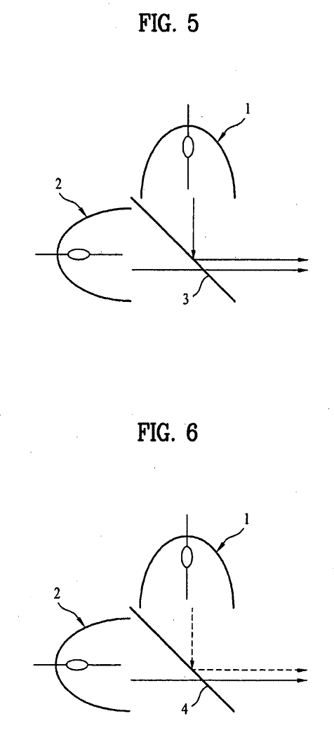

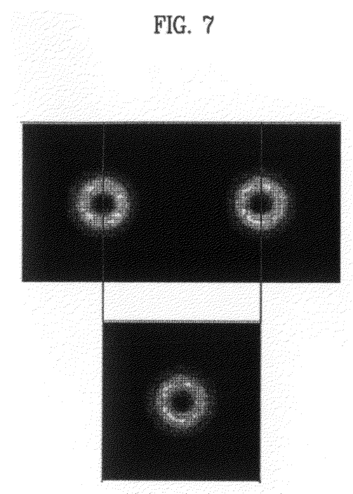

One of the methods of composing the two lamps such the path is shown in FIG. 5. As shown in FIG. 5, two different light sources 1 and 2 may be composed by wavelength of light, using a dichroic mirror or dichroic prism 3. According to another method as shown in FIG. 6, two different light sources 1 and 2 may be composed by polarized light, using a polarizing beam splitter (PBS) 4.

However, it is impossible to apply the above methods shown in FIGS. 5 and 6 to a conventional UHL lamp. To compose the light emitted from the two different lamps 1 and 2 in a single path, the light is composed by wavelength or polarized light. The conventional UHP lamp is a white light source that is unpolarized.

Spatial irradiance in case of two different lamps arranged in parallel and spatial irradiance in case of a single lamp are shown in FIG. 7. FIG. 7 means that the brightness of the optical system configured of two lamps arranged in parallel is substantially identical to the brightness of the optical system configured of a single lamp.

That is, an effective area of the optical system configured of the two lamps is identical to an effective area of the optical system configured of the single lamp. As a result, although two lamps are used in the identical area, there is no increase of brightness.

A method of increasing brightness by using two lamps according to the present invention will be described as follows.

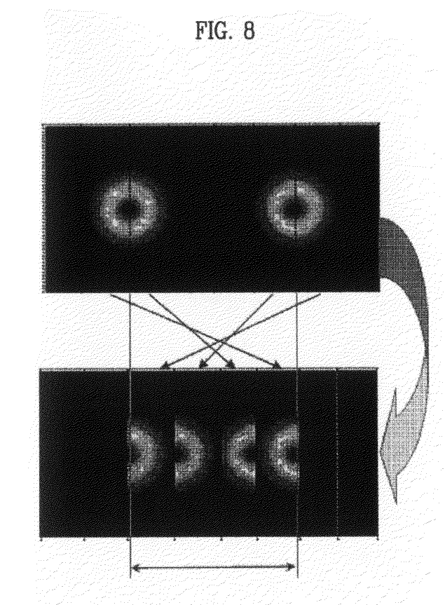

As shown in FIG. 8, if the spatial irradiance in case of arranging two different lamps in parallel is divided and re-arranged as follows, the etendue may not changes. However, if the spatial distribution is changed by such the re-arrangement, brightness of an optical system used actually may be increased.

Here, the reason why the etendue is not changed is that the etendue is in relation to an area and angle and that the angle of the lamp is not changed. As shown in FIG. 8, an overall area may not be changed.

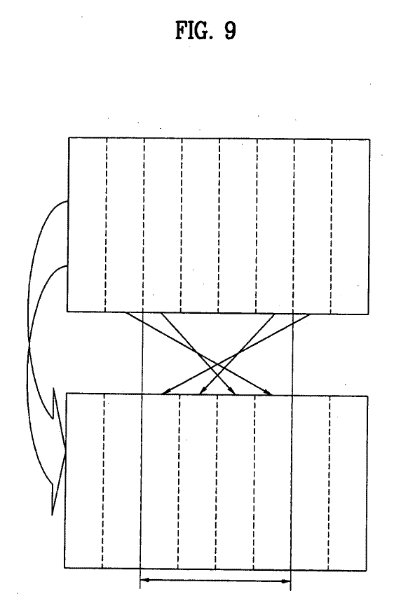

As shown in FIG. 9, light flux of a uniform light source may not be changed in an effective area and thus the brightness of the optical system may not be changed. As shown in FIG. 8, light flux of a light source such as a lamp having irradiance that is not uniform may be increased in the effective area and thus the brightness of the optical system may be increased.

To increase the brightness of the optical system without changes of characteristics of the etendue, spatial irradiance of the two lamps is divided and re-arranged. For that, a prism may be useable.

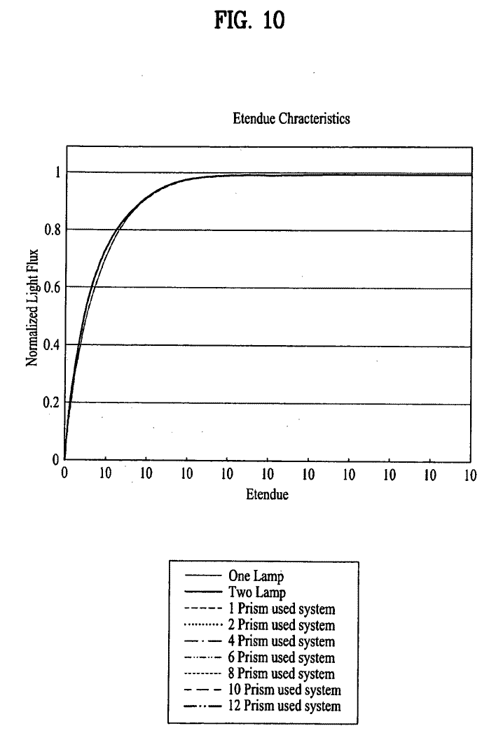

FIG. 10 shows that the etendue of the optical system may not be changed regardless of the number of used lamps and the usage of the prism.

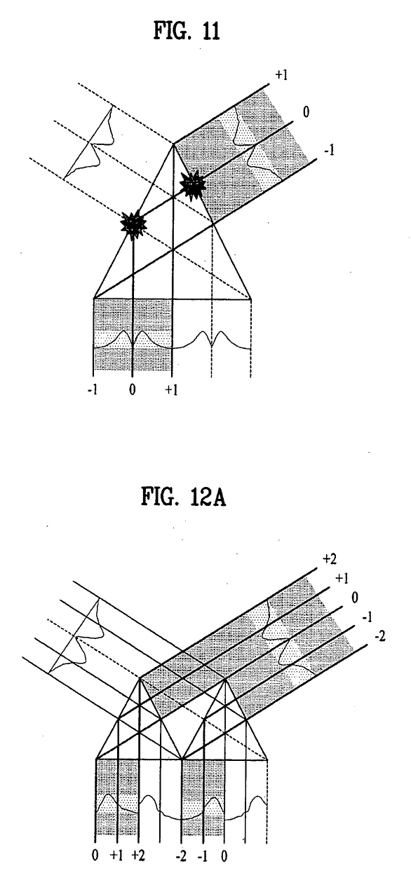

As shown in FIG. 11, light perpendicularly incident on a surface of a prism 5 is totally reflected in an inner surface of the prism 5 to be emitted outside, such that the distribution of space having the light incident on may be re-arranged.

That is, light positioned in ‘−1’ that is incident on a center of the prism 5 is emitted to an outside of the prism 5. Light positioned in ‘1’ that is incident on the outside of the prism 5 is emitted to the center of the prism 5.

In case of using the single prism 5, overall light space may not be changed.

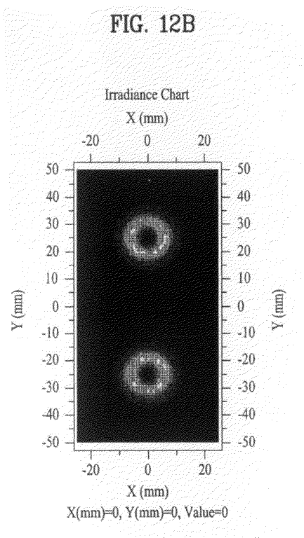

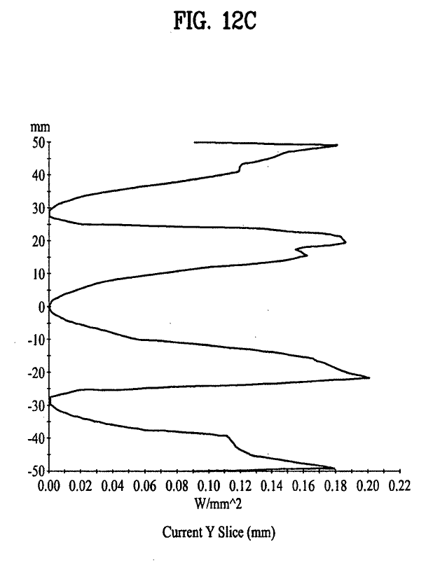

FIG. 12a shows a case of using two prisms 5. Even in this case, as shown in FIGS. 12a and 12c, spatial irradiance in each center is changed.

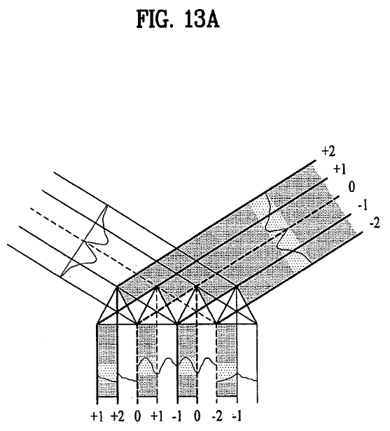

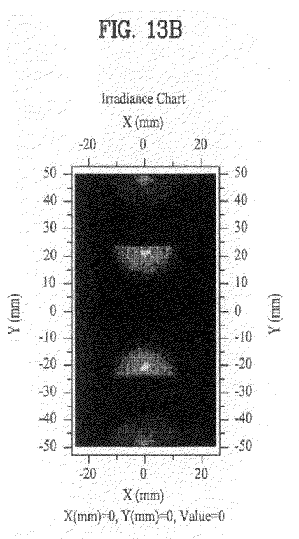

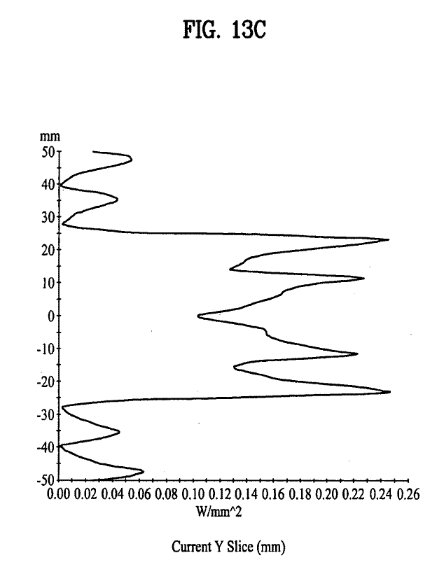

FIG. 13a shows spatial re-arrangement of light in case of using four prisms 5. As shown in FIGS. 13b and 13c, more light is intensively concentrated on the centers in case of using four prisms than in case of using two prisms 5, such that distribution of light space is changed.

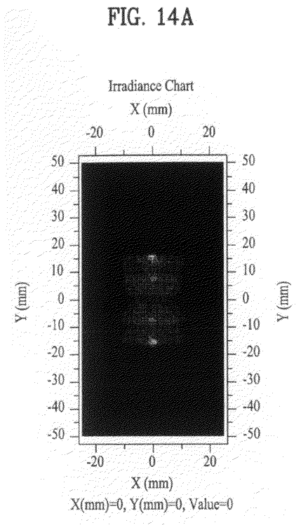

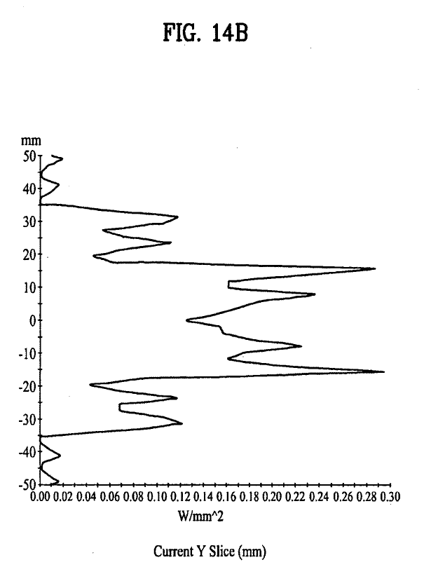

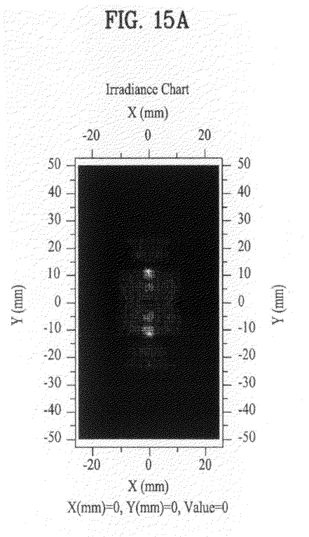

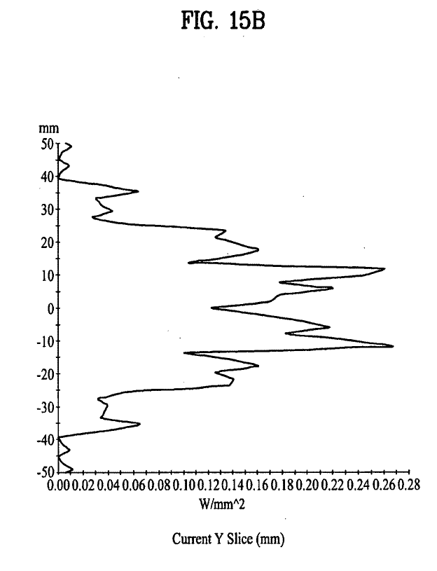

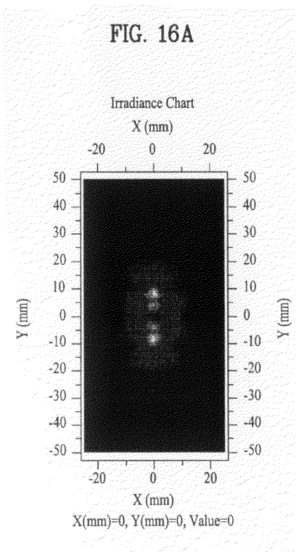

FIGS. 14a and 14b show changes of spatial irradiance in case of using six prisms. FIGS. 15a and 15b show changes of spatial irradiance in case of using eight prisms.

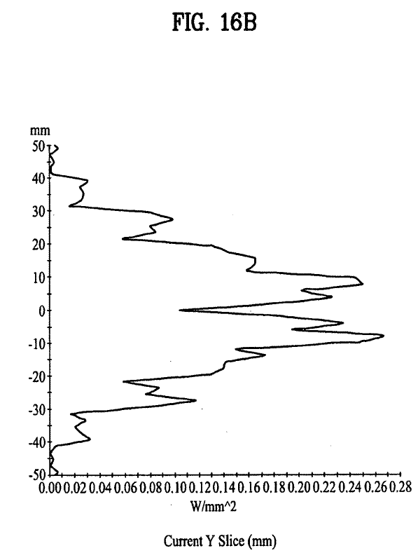

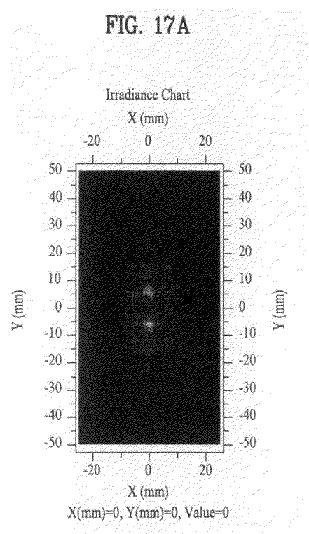

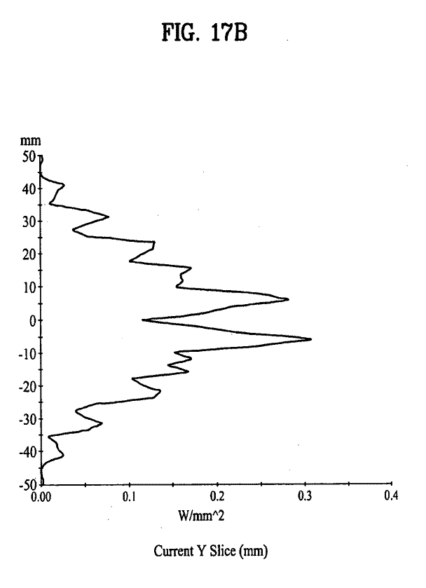

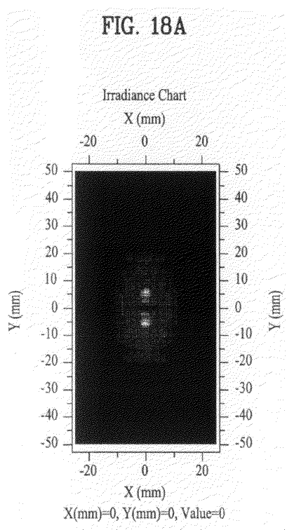

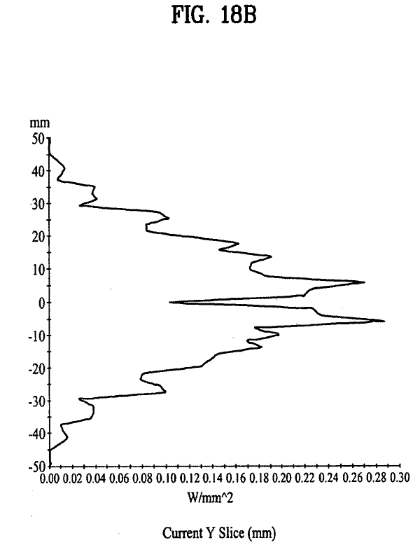

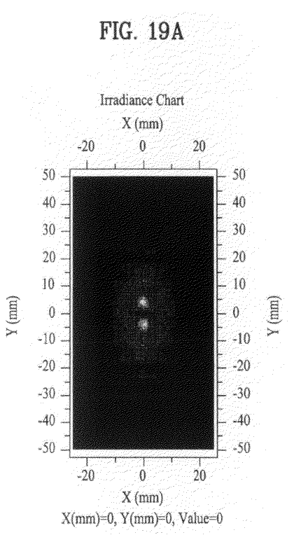

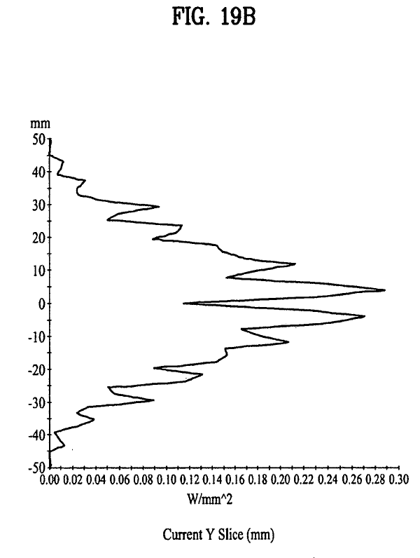

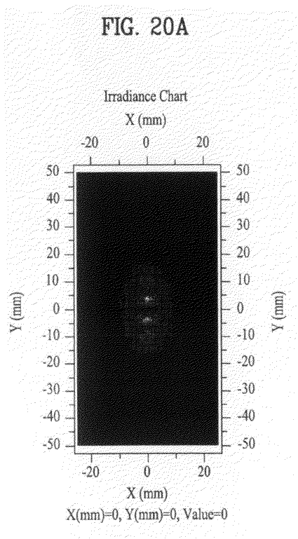

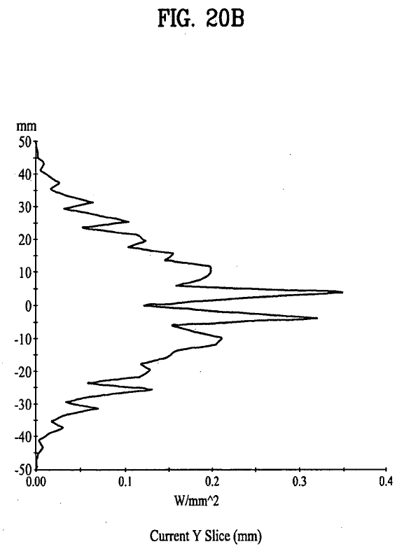

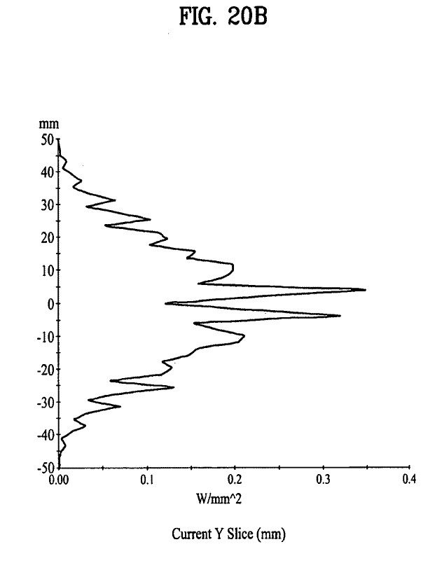

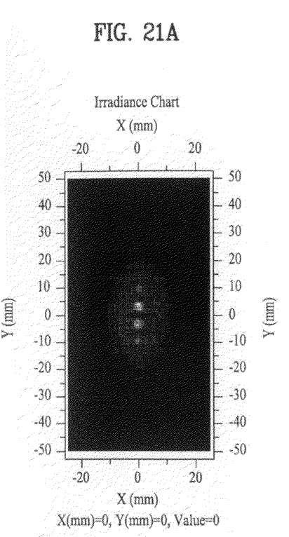

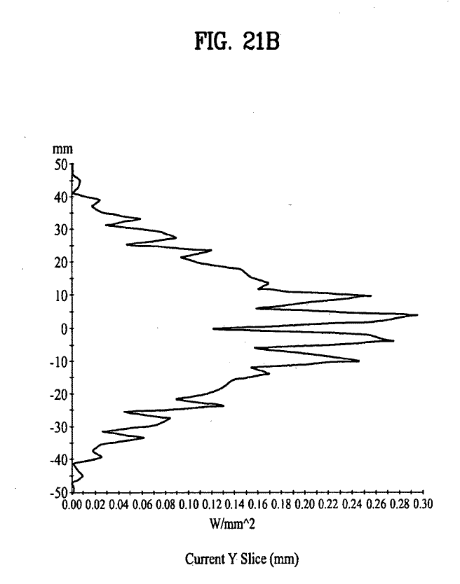

FIGS. 16a and 16b show changes of spatial irradiance in case of using ten prisms. FIGS. 17a and 17b show changes of spatial irradiance in case of using twelve prisms. FIGS. 18a and 18b show changes of spatial irradiance in case of using fourteen prisms. FIGS. 19a and 19b show changes of spatial irradiance in case of using sixteen prisms. FIGS. 20a and 20b show changes of spatial irradiance in case of using eighteen prisms. FIGS. 21a and 21b show changes of spatial irradiance in case of using twenty prisms.

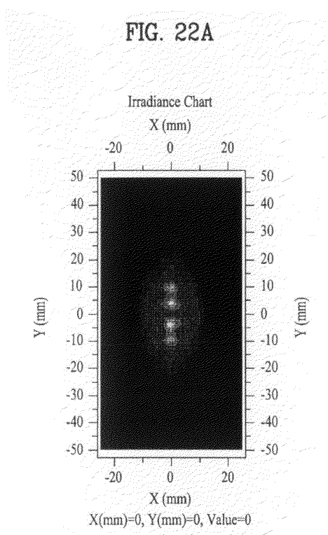

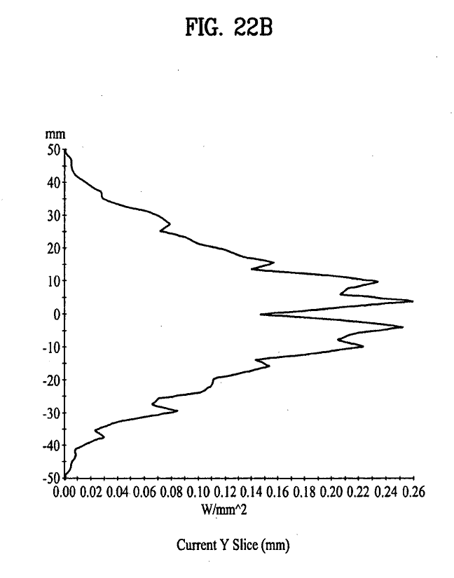

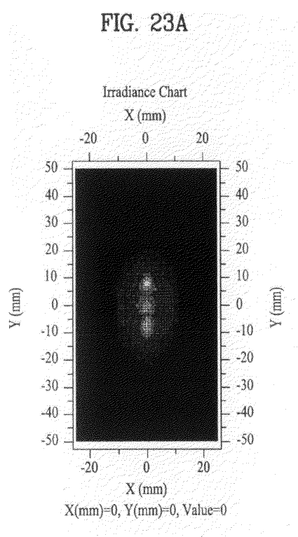

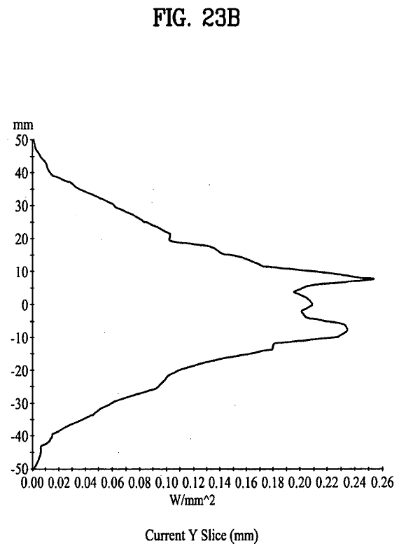

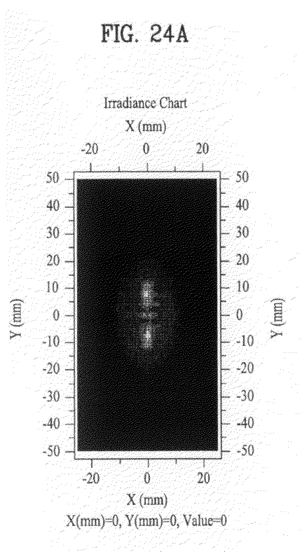

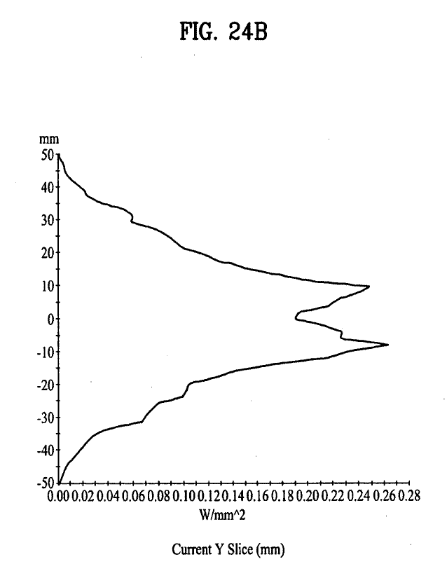

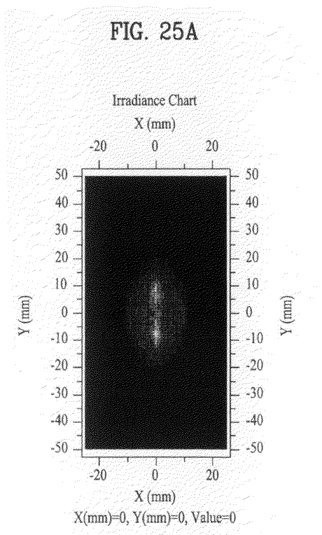

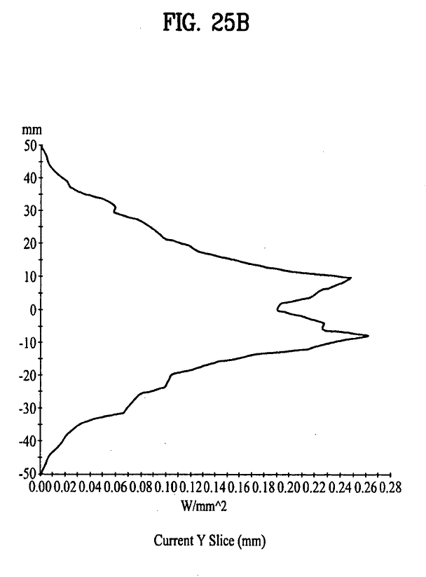

In addition, FIGS. 22a and 22b show changes of spatial irradiance in case of using forty prisms. FIGS. 23a and 23b show changes of spatial irradiance in case of using sixty prisms. FIGS. 24a and 24b show changes of spatial irradiance in case of using eighty prisms. FIGS. 25a and 25b show changes of spatial irradiance in case of using one hundred prisms.

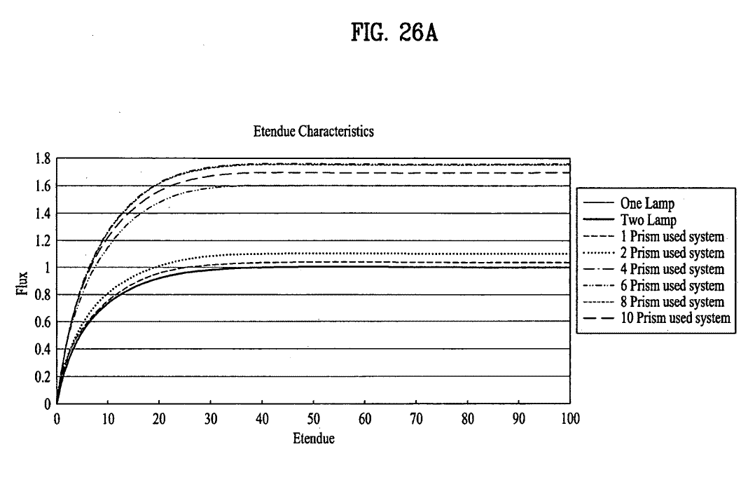

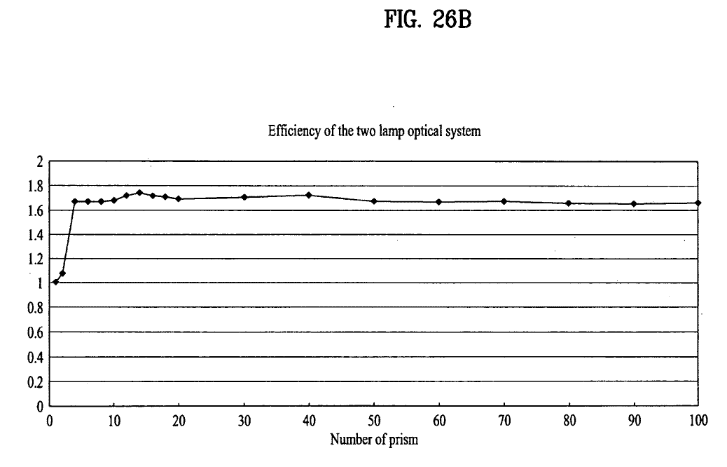

In case of using plural prisms, the brightness of the optical system is increased and the improved efficiency of the optical system is shown in a graph of FIG. 26.

As shown in FIG. 26, the brightness is increased drastically in case of using four prisms and it is not increased so much even in case of increasing the number of the prisms by one hundreds.

After the spatial light re-arrangement using the prisms, the case of using two lamps has brightness that is increased by approximately 1.7 times, compared to the case of using the single lamp.

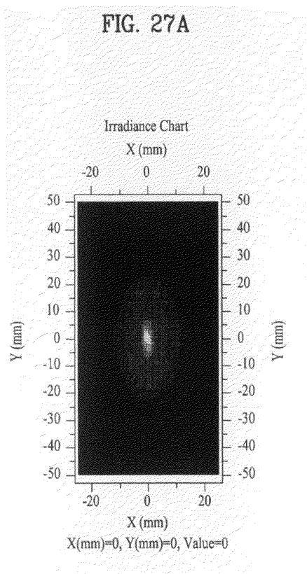

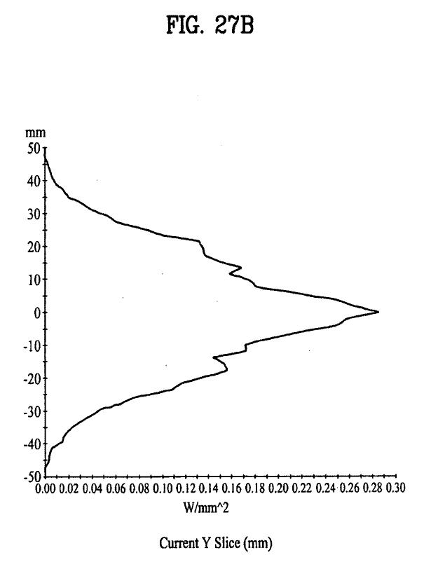

FIGS. 27a and 27b show that light emitted from two lamps is composed only to have a complete single irradiance. Here, the brightness is increased by approximately 1.74 times. Even when the light emitted from the two lamps is composed to have the complete single irradiance, the brightness may not be increased noticeably in comparison to the brightness of the two lamps having the light re-arranged by using four prisms.

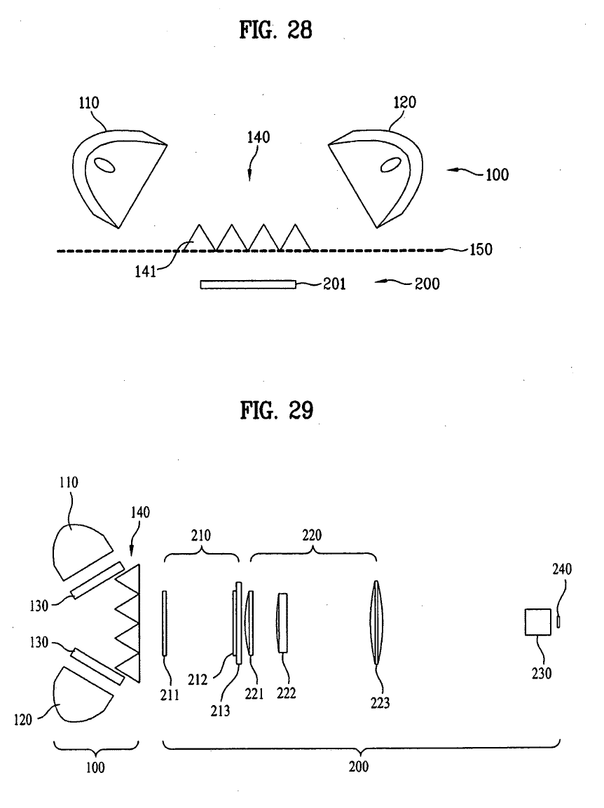

FIG. 28 shows an embodiment of a projector system including an illumination system 100 having brightness increased by using the prism in the method mentioned above.

Such the illumination system 100 includes two light sources 110 and 120 making light incident on a single incident surface 150 and a light source composition part 140 configured of plural prisms arranged in the incident surface 150.

As mentioned above, the light source composition part 140 is configured of a plurality of prisms 141 and at least four prisms may compose and increase the brightness of the two light sources 110 and 120 enough. That is, this embodiment adapts the light source composition system mentioned in reference to FIG. 13. Here, the spatial irradiance of this case is identical to that of FIG. 13b.

The light emitted from the illumination system 100 is incident on an optical system 200. FIG. 27 shows that the optical system 200 is embodied as a receiver 201 having a single effective area.

Here, the prism 141 may be a regular triangle-shaped prism 141. Such the prism 141 allows the light emitted from each of the light sources 110 and 120 to be perpendicularly incident on a surface of the receiver 201.

Alternatively, the prism 141 may be an isosceles triangle, including right-angled triangle, shaped prism 141. At this time, this prism should have a predetermined angle that allows the light incident from the light sources 110 and 120 to be totally reflected only to be incident on the surface of the receiver 201.

The illumination system 100 including such the light source composition part 140 may be typically effective when using a UHP lamp such as a high pressure mercury lamp and it may be effective when using a light emitting device such as LED and LD.

A lens 130 may be further provided between the light sources 110 and 120 and the light source composition part 140 such that the light incident from the light sources 110 and 120 may be intensively concentrated.

FIG. 29 illustrates an embodiment of a projection system using such the illumination system. That is, the light emitted from the illumination system 100 is incident on an imager 240 after passing a parallel light conversion 201 and an illumination lens part 220 sequentially.

Here, the parallel light conversion 210 may be configured of an array including fly eye lens 211 and 212 and a PBS 213. The illumination lens part 220 may include a plurality of illumination lens 221, 222 and 223.

The PBS may be provided between the illumination lens part 220 and the imager 240. Such the imager 240 may use various channels such as LCoS, LCD, MD (micro device) and the like.

Here, a prism, a dichroic mirror and the light may be further provided to transmit images formed by such the imager 240.

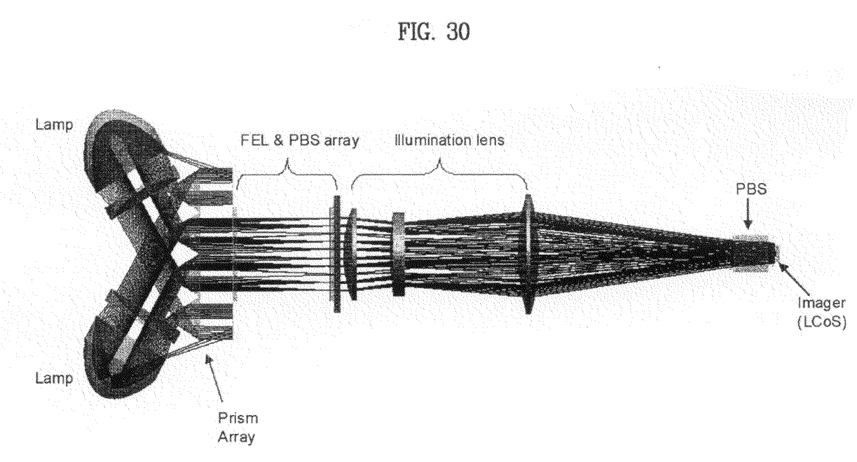

FIG. 30 visually illustrates a progress of light in the projection system having the configuration shown in FIG. 29.

As shown in FIG. 30, the light incident from the two light sources is spatially re-arranged and intensively concentrated by the prism such that the progress of the light may be visible.

The projection system according to the present invention will be described in detail as follows.

The projection system according to the present invention includes the plurality of light sources 110 and 120, the light source composition part 140 and the optical system 200.

Here, at least two light sources may be provided and each of the light sources may use at least one of a UHP lamp, LED and LD that generate white unploralized light.

The lights generated from the plurality of the light sources 110 and 120 may be incident on the identical incidence surface 150.

The light source composition part 140 composes the light incident from the plurality of the light sources 110 and 120 and it may have a plurality of protrusions facing the light sources.

Here, it is preferable that four protrusions are provided in the light source composition part and each of the protrusions may have first and second surfaces perpendicular to a light shaft of the light incident from the light sources.

As a result, the light sources and the protrusions are arranged for the light source emitting the light to the first surface of the protrusions

A first surface of one protrusion is facing a second surface of another one adjacent to the protrusion. A second surface of one protrusion is facing a first surface of another adjacent to the protrusion.

Here, a section of each protrusion provided in the light source composition part may be regular triangle or isosceles triangle shaped.

The light source composition part 140 may be configured of at least four prisms 141 arranged on the identical incidence surface 150 in parallel, instead of the protrusions.

As shown in FIG. 29, the projection system according to the present invention may further include a lens 130 provided between the light sources 110 and 120 and the light source composition part 140.

As shown in FIG. 29, it may further include the optical system 200 emitting outside the light composed by the light source composition part 140. The configuration of the optical system 200 will be described as follows.

The optical system 200 includes the parallel light converting part 210, an illumination lens part 220, the PBS (polarizing beam splitter) 230 and the imager 240. The light composed by the light source composition part 140 is incident on the parallel light conversion 210 and the light of the parallel light conversion 210 is incident on the illumination lens part 220. The light of the illumination lens part 220 is incident on the PBS 230.

In another aspect, a projection system according to an exemplary embodiment of the present invention may include first and second light sources 110 and 120, a plurality of prisms 141 and an optical system 200 as shown in FIGS. 28 and 29. The first and second light sources 110 and 120 emit lights to an identical incidence surface 150. The plurality of the prisms 141 are arranged on the incidence surface 150 in parallel and they compose the lights incident from the first and second light sources 110 and 120. The optical system 200 emits the light composed by the prisms 141 outside.

Here, it is preferable that the first and second light sources 110 and 120 may generate white unpolarized light and that at least four prisms are provided.

Each of the prisms 141 may have a triangular prism shape having first, second third surfaces.

Here, the first surface of each prism 141 is perpendicular to a light shaft of the light incident from the first light source 110. The second surface of each prism is perpendicular to a light shaft of the light incident from the second light source 120. The third surface of each prism 141 is in parallel to the incidence surface 150.

The first surface of one of prisms 141 faces the second surface of another adjacent to the prism 141. The second surface of one of the prisms 141 faces the first surface of another adjacent to the prism 141. An edge of the third surface of one of the prisms 141 is in contact with an edge of the third surface of another adjacent to the prism 141.

As mentioned above, the present invention has an effect that the projection system having 1.7 times more increased brightness with composing two light sources and maintaining optical characteristics identical to the case of using a single light source may be embodied. Here, the optical characteristics may be the angle of light that is incident on light parts after incident from a light source and the width of beam.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A projection system comprising:
a plurality of light sources generating light;
a light source composition part including a plurality of protrusions facing the light sources, respectively, to combine the light incident from the light sources; and
an optical system emitting the light from the light source composition part.

2. The projection system of claim 1, wherein at least two light sources are included.

3. The projection system of claim 1, wherein each of the light sources is one of an ultra-high pressure (UHP) lamp, light-emitting diode (LED) and laser diode (LD).

4. The projection system of claim 1, wherein each of the light sources generates white unpolarized light.

5. The projection system of claim 1, wherein the light generated from the plurality of the light sources are incident on identical incidence surfaces of the light source composition part.

6. The projection system of claim 1, wherein the light source composition part includes at least four protrusions.

7. The projection system of claim 1, wherein each of the protrusions includes a first surface that is substantially perpendicular to a direction of the light incident from the light source and a second surface.

8. The projection system of claim 7, wherein the light source emitting the light to the first surface of each protrusion is different from the light source emitting the light to the second surface of each protrusion.

9. The projection system of claim 7, wherein the first surface of a first protrusion faces the second surface of a second protrusion that is adjacent to the first protrusion and the second surface the second protrusion faces the first surface of a third protrusion that is adjacent to the second protrusion.

10. The projection system of claim 1, wherein a section of each protrusion of the light source composition part is one of a regular and an isosceles triangle-shaped.

11. The projection system of claim 1, wherein the light source composition part includes at least four prisms arranged on a single surface in parallel.

12. The projection system of claim 1, wherein a lens is arranged between the plurality of the light sources and the light source composition part.

13. The projection system of claim 1, wherein the optical system comprises,
a parallel light conversion unit having the light combined by the light source composition part incident thereon;
an illumination lens part having the light incident thereon from the parallel light conversion part; and
an imager having the light incident thereon from the illumination lens part.

14. A projection system comprising:
first and second light sources generating light towards an incidence surface;
a plurality of prisms arranged on the incidence surface in parallel to combine the light of the first and second light sources; and
an optical system emitting the light combined by the plurality of the prisms.

15. The projection system of claim 14, wherein the first and second light sources generate white unpolarized light.

16. The projection system of claim 14, wherein at least four prisms are included.

17. The projection system of claim 14, wherein each of the prisms has a triangular prism shape having a first, second, and third surface.

18. The projection system of claim 17, wherein the first surface of each prism is substantially perpendicular to the light incident from the first light source, and the second surface of each prism is substantially perpendicular to the light incident from the second light source, and the third surface of each prism is substantially parallel to the incidence surface.

19. The projection system of claim 17, wherein the first surface of a first prism faces the second surface of a second prism that is adjacent to the first prism, and the second surface of the second prism faces the first surface of a third prism that is adjacent to the second prism, and an edge of the third surface of the first prism is in contact with an edge of the third surface of the second prism that is adjacent to the first prism.

20. The projection system of claim 14, wherein a lens is arranged between the first and second light sources and the prism.

21. A projection system comprising:
a first light source producing light in a first direction and a second light source producing light in a second direction;
a prism structure having a plurality of projections, wherein each projection has a first surface substantially perpendicular to light produced from the first light source and a second surface substantially perpendicular to light produced from the second light source, and wherein the prism has a third surface though which light incident from the first and second light sources is emitted; and
an optical system that receives the light from the prism structure and produces an image.

22. The projection system of claim 21, wherein each of the light sources is one of an ultra-high pressure (UHP) lamp, light-emitting diode (LED) and laser diode (LD).

23. The projection system of claim 21, wherein each of the light sources generates white unpolarized light.

24. The projection system of claim 21, wherein the prism structure includes at least four prisms.

25. The projection system of claim 21, wherein the light from the first light source is not incident on the second surface of each prism and the light from the second light source is not incident on the first surface of each prism.

26. The projection system of claim 21, wherein a section of each prism of the prism structure is one of a regular and an isosceles triangle shape.

27. The projection system of claim 21, wherein the prism structure includes at least four prisms arranged on a single surface in parallel.

28. The projection system of claim 21, wherein a lens is arranged between the plurality of the light sources and the prism structure.

29. The projection system of claim 21, wherein the optical system comprises,
a parallel light conversion unit having the light combined by the light source composition part incident thereon;
an illumination lens part having the light incident thereon from the parallel light conversion part; and
an imager having the light incident thereon from the illumination lens part that produces an image.
